(19) United States
(12) Patent Application Publication
(10) Pub. No.: US 2023/0354988 A1
(43) Pub. Date: Nov. 9, 2023

(54) SYSTEMS AND METHODS FOR WIRE BRISTLE TUFT ATTACHMENT

(71) Applicant: Mr. Bar-B-Q Products LLC, Hauppauge, NY (US)

(72) Inventors: Marc Zemel, Hauppauge, NY (US); Jing Qiu Chen, Sheung Wan (HK)

(21) Appl. No.: 18/135,833

(22) Filed: Apr. 18, 2023

Related U.S. Application Data
(60) Provisional application No. 63/338,937, filed on May 6, 2022.

(51) Int. Cl. A46B 3/16; A46D 3/04; A46D 3/08

(52) U.S. Cl. CPC A46B 3/16; A46D 3/042; A46D 3/087; A46B 2200/3073; A46B 2200/3093; A47J 37/0786

(57) ABSTRACT

A method for wire bristle tuft attachment. The method includes clamping a brush head of a grill brush using a fixture, arranging a plurality of bristles to form a bristle grouping using a terminal, inserting the plurality of bristles in a recess in the brush head, and forming an irregular bend in the terminal by pressing the terminal into the recess by a press machine.

### CROSS-REFERENCE TO RELATED APPLICATIONS

The present application claims the benefit of and priority to U.S. Provisional Patent Application Ser. No. 63/338,937, filed on May 6, 2022, the entire contents of which are incorporated by reference herein.

### TECHNICAL FIELD

This disclosure relates to grill brushes and more particularly, to systems and methods for improved wire-bristle tuft attachment strength and wire-bristle durability.

### BACKGROUND

Conventional wire brushes including bundles or tufts of wire bristles may present a hazard when wire bristle segments separate from the brush and fall onto a grill grate while a user is cleaning grates of a grill. For example, one or more of the bristles may become lodged in a food product which may then be consumed by a user. Consumption of a wire bristle may be harmful a user's health. Currently, Canadian Standard Association (CSA) has issued voluntary safety standards to address hazards that may be caused by people ingesting food prepared on a barbecue grill previously cleaned by a metal barbecue grill brush.

Accordingly, improvements are needed to provide grill brushes that are CSA compliant and which do not pose a risk of ingestion with food cooked on a grill.

### SUMMARY

In accordance with aspects of this disclosure, a method for wire bristle tuft attachment includes clamping a brush head of a grill brush using a fixture, arranging a plurality of bristles to form a bristle grouping using a terminal, inserting the plurality of bristles in a recess in the brush head and forming an irregular bend in the terminal by pressing the terminal into the recess by a press machine. The plurality of bristles may be adjacent and substantially parallel to one another.

In an aspect of this disclosure, the method may further include forming a terminal from a wire, wherein the wire has a metal cross-section and wherein the terminal is made of metal.

In an aspect of this disclosure, the method may further include controlling a height of the plurality of bristles based on a vertical displacement of the fixture.

In another aspect of this disclosure, the method may further include controlling a height of the plurality of bristles by controlling a vertical displacement of a head of the press machine.

In yet another aspect of this disclosure, the method may further include controlling a location of the bristle grouping in the brush head based on controlling at least one of a vertical displacement or a horizontal displacement of the brush head.

In a further aspect of this disclosure, the press machine may be further configured to mechanically couple the plurality of bristles to the brush head such that a strength and durability of the plurality of bristles is not compromised when a force of greater than about 89 Newtons is applied.

In yet a further aspect of this disclosure, the brush head may be made of polypropylene.

In an aspect of this disclosure, a diameter of the recess may be about 2.5 mm.

In another aspect of this disclosure, a length of the terminal may be between about 2.2 mm to about 2.8 mm.

In yet another aspect of this disclosure, a diameter of the terminal may be between about 0.7 mm to about 0.8 mm.

In accordance with aspects of this disclosure, a system for wire bristle tuft attachment is presented. The system includes a press machine and a fixture. The press machine is configured to mechanically couple a plurality of bristles to a brush head of a grill brush by inserting the plurality of bristles in a recess in the brush head and applying a force to a terminal to form an irregular bend in the terminal by pressing the terminal into the recess; and a fixture disposed on the press machine, the fixture configured to clamp and position a brush head for the mechanical coupling of the plurality of bristles to the brush head.

In an aspect of this disclosure, the press machine may be further configured to form the terminal from a wire.

In an aspect of this disclosure, the fixture may be further configured to control a height of the plurality of bristles based on a vertical displacement of the fixture.

In another aspect of this disclosure, the fixture may be further configured to control a height of the plurality of bristles relative to a top surface of the brush head.

In yet another aspect of this disclosure, the system may be further configured to arrange a plurality of bristles to form a bristle grouping using a terminal. The press machine may be configured to control a location of the bristle grouping in the brush head based on controlling a vertical displacement and/or a horizontal displacement of the brush head.

In a further aspect of this disclosure, the press machine may be further configured to control the applied force to deform the terminal in the recess of the brush head.

In yet a further aspect of this disclosure, a length of the terminal may be between about 2.2 mm to about 2.8 mm.

In an aspect of this disclosure, a diameter of the terminal may be between about 0.7 mm to about 0.8 mm.

In another aspect of this disclosure, the press machine may be further configured to mechanically couple the plurality of bristles to the brush head such that a strength and durability of the plurality of bristles is not compromised when a force of greater than about 89 Newtons is applied.

In another aspect of this disclosure, the press machine may be further configured to control a height of the plurality of bristles by controlling a vertical displacement of a head of the press machine.

Other aspects, features, and advantages will be apparent from the description, the drawings, and the claims that follow.

### BRIEF DESCRIPTION OF THE DRAWINGS

A better understanding of the features and advantages of the disclosed technology will be obtained by reference to the following detailed description that sets forth illustrative embodiments, in which the principles of the technology are utilized, and the accompanying figures of which:

FIG. 1 is an image of a system for wire bristle tuft attachment, in accordance with the principles of this disclosure;

FIGS. 2 and 3 are images of a grill brush for use with the system of FIG. 1, in accordance with the principles of this disclosure;

FIGS. 4 and 5 are images of terminals and bristles for use with the system of FIG. 1, in accordance with the principles of this disclosure;

FIG. 6 is a side cutaway view of the grill brush of FIG. 1 before deforming the terminals using the system of FIG. 1, in accordance with the principles of this disclosure;

FIG. 7 is a side cutaway view of the grill brush of FIG. 1 after deforming the terminals using the system of FIG. 1, in accordance with the principles of this disclosure;

FIG. 8 is an image of a fixture of the system of FIG. 1, in accordance with the principles of this disclosure;

FIG. 9 is an image of the fixture of FIG. 8 mounted to a press machine of the system of FIG. 1, in accordance with the principles of this disclosure;

FIGS. 10-12 are images of the press machine of FIG. 9, in accordance with the principles of this disclosure; and

FIG. 13 is an exemplary control screen for the system of FIG. 1, in accordance with the principles of this disclosure.

Other aspects, features, and advantages will be apparent from the description, the drawings, and the claims that follow.

### DETAILED DESCRIPTION

This disclosure relates to grill brushes and, more particularly, to systems and methods for improved wire-bristle tuft attachment strength and wire-bristle durability.

Although illustrative systems of this disclosure will be described in terms of specific aspects, it will be readily apparent to those skilled in this art that various modifications, rearrangements, and substitutions may be made without departing from the spirit of this disclosure.

For purposes of promoting an understanding of the principles of this disclosure, reference will now be made to exemplary aspects illustrated in the figures, and specific language will be used to describe the same. It will nevertheless be understood that no limitation of the scope of this disclosure is thereby intended. Any alterations and further modifications of this disclosure, any features illustrated herein, and any additional applications of the principles of this disclosure as illustrated herein, which would occur to one skilled in the relevant art and having possession of this disclosure, are to be considered within the scope of this disclosure.

In the following description, well-known functions or constructions are not described in detail to avoid obscuring the present disclosure in unnecessary detail.

The Canadian Standard Association (CSA) has issued voluntary safety standards to address hazards such as alimentary tract injuries that may be caused by people ingesting bristles left on a barbecue grill when cleaned by a low quality and strength metal barbecue grill brush. Standard brushes use a flat metal terminal and cannot meet the CSA standard. CSA Z630:19 clause 5 test methods generally include testing: (1) wire bristle tuft attachment strength, (2) wire bristle durability, (3) replacement heads, (4) permanent on-product warning requirements, and (5) requirements for instructional literature. The disclosed systems and methods enable improved wire-bristle tuft attachment strength and wire-bristle durability that meet or exceed CSA Z630:19 Barbecue grill brushes standards.

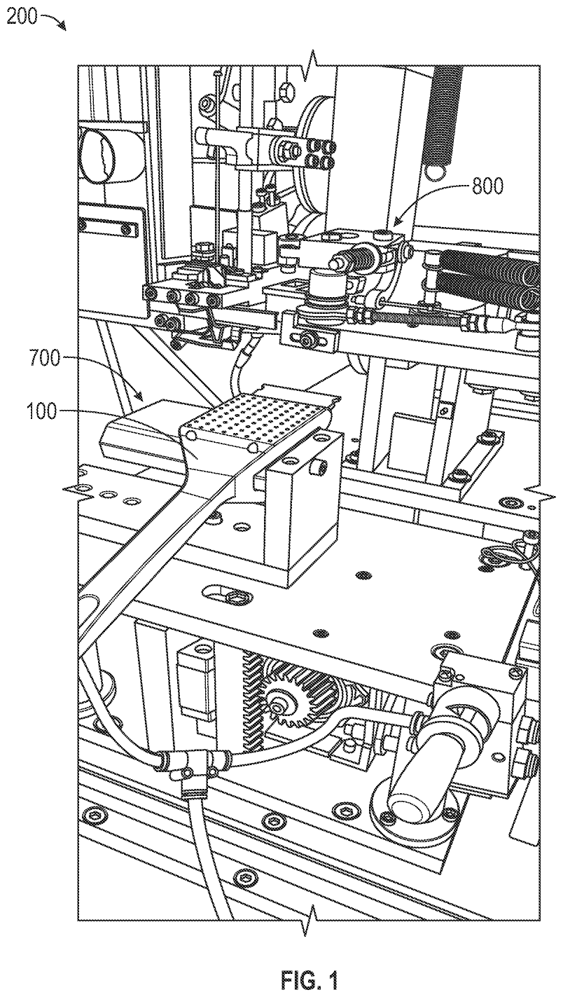

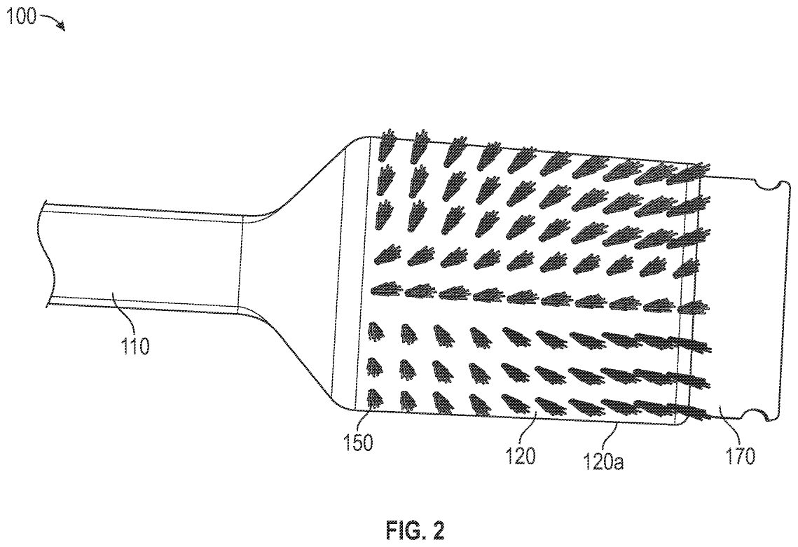

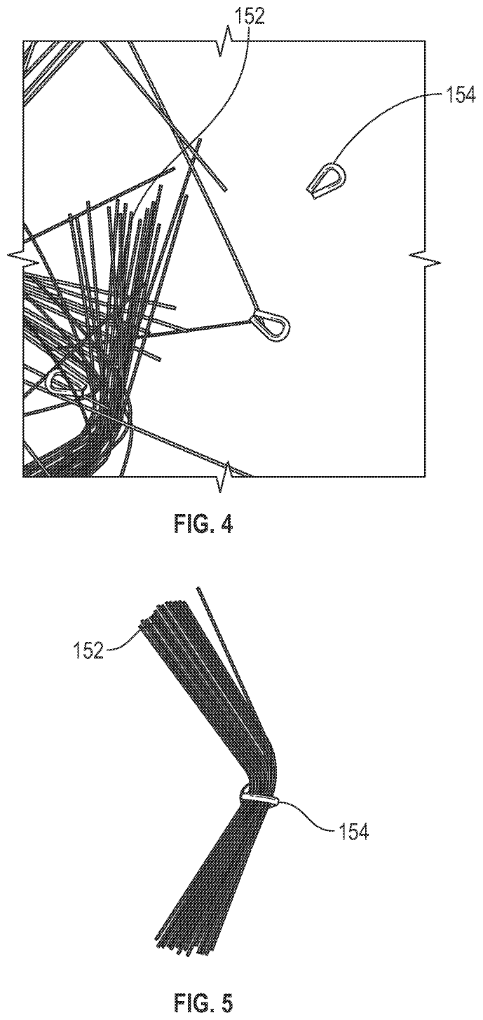

Referring to FIG. 1, a system 200 for wire bristle tuft attachment is shown. The system 200 for wire bristle tuft attachment generally includes a press machine 800 and a fixture 700. The press machine 800 is configured to mechanically couple a plurality of bristles 152 to a brush head 120 of a grill brush 100 (FIGS. 2, 4). The term “fixture” as used herein can also be referred to as substrate or jigs.

The fixture 700 is disposed on the press machine 800. The fixture 700 is configured to clamp and position a brush head 120 for the mechanical coupling of the plurality of bristles 152 to brush head 120. The fixture 700 may include any suitable substrate or suitable mechanism configured for holding and positioning the brush head 120.

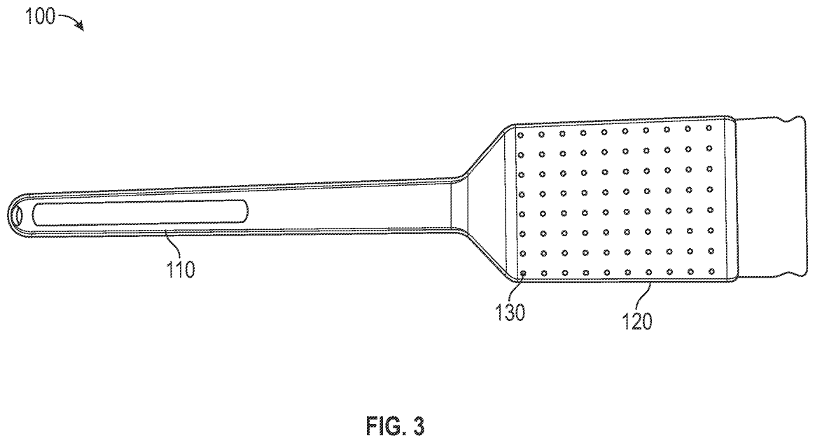

The press machine 800 is configured to mechanically couple a plurality of bristles 152 to a brush head 120 of a grill brush 100 by inserting the plurality of bristles in a recess 130 in brush head 120 (FIG. 3). The press machine 800 applies a force to a terminal 154 to form an irregular bend in the terminal 154 (FIG. 4) by pressing the terminal into the recess 130. A larger sized brush head may have, for example, about 165 recesses 130, and a smaller sized brush head may have about 72 recesses 130.

Referring to FIGS. 2 through 4, grill brush 100 is shown. The grill brush 100 generally includes a handle 110 and a brush head 120. The grill brush 100 may be made of polypropylene plastic or any other suitable material. The grill brush 100 may be made using processes such as polypropylene plastic injection. The brush head 120 includes recess 130 in which a bristle grouping 150 is inserted using the disclosed systems and methods. The bristle grouping 150 includes a plurality of bristles 152 grouped together using a terminal 154. In aspects, grill brush 100 may include scraper 170. The scraper 170 may be made of stainless steel or other suitable material. The bristles may be stainless steel or any other suitable material. The recess 130 may have a diameter of about 2.5 mm+/−about 0.1 mm.

Referring to FIGS. 4 and 5, terminals 154 and bristles 152 are shown. The terminal(s) 154 may be made from wire and may be formed in a mold in a “u” like shape. Although a “u” shape is used here as an example, other suitable shapes are contemplated. The plurality of bristles 152 may be arranged to form a bristle grouping 150 using terminal 154. The plurality of bristles 152 may be adjacent and substantially parallel to one another. The diameter of the terminal may be between about 0.7 mm to about 0.8 mm. The length of the terminal may be between about 2.2 mm to about 2.8 mm.

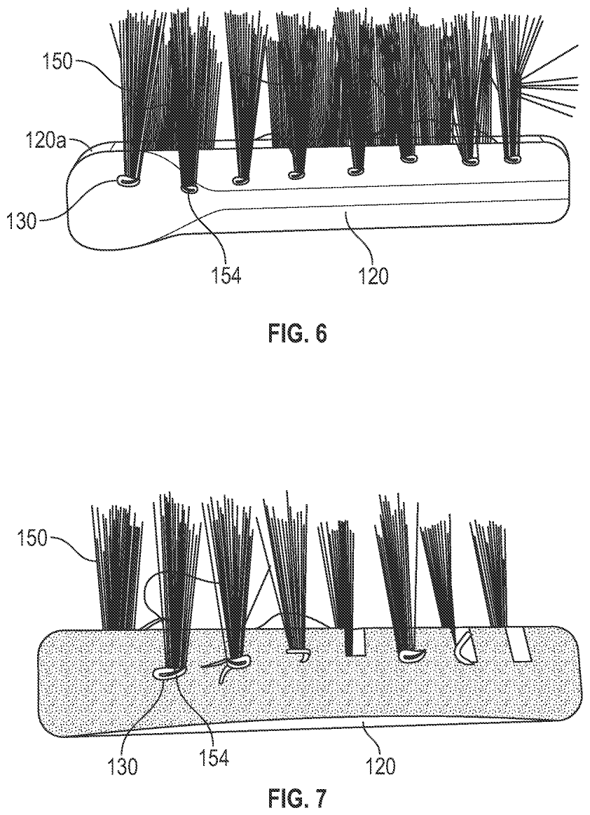

Referring to FIG. 6, a side cutaway view of brush head 120 before an irregular bend in the terminal has been formed is shown. FIG. 7 shows a side cutaway view of brush head 120 after the irregular bend in the terminal has been formed. The bristles 152 are pressed into the recess(es) 130 with terminal 154 so that when pressed by press machine 800, terminal 154 bends irregularly to sit into brush head 120. The forming of an irregular shape in the terminal provides additional strength and durability, which is a benefit for grill brush 100 when tested against the CSA Z630:19 wire-bristle tuft attachment strength test and wire-bristle durability test—cycle and load force.

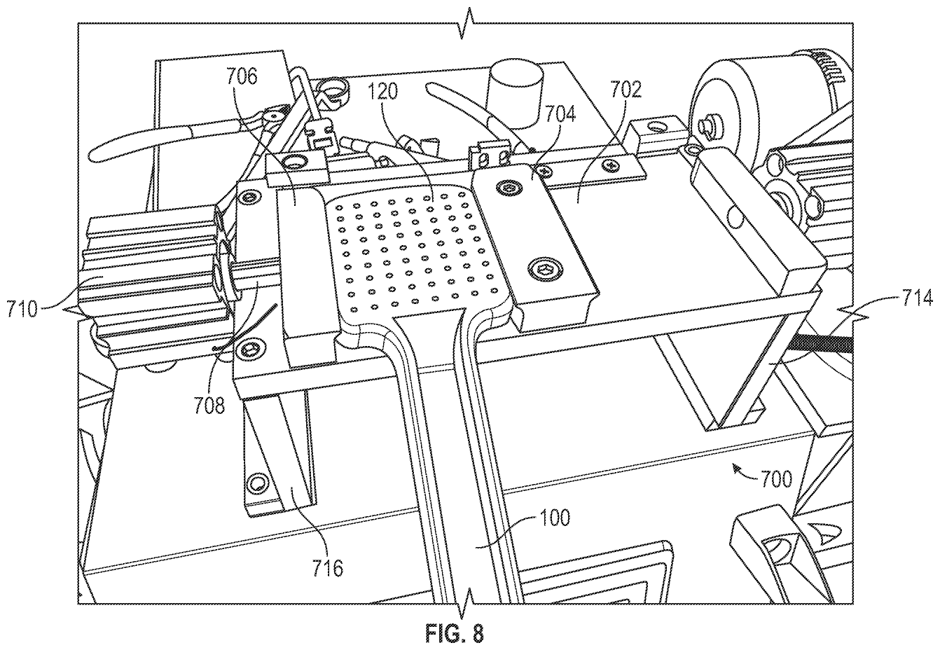

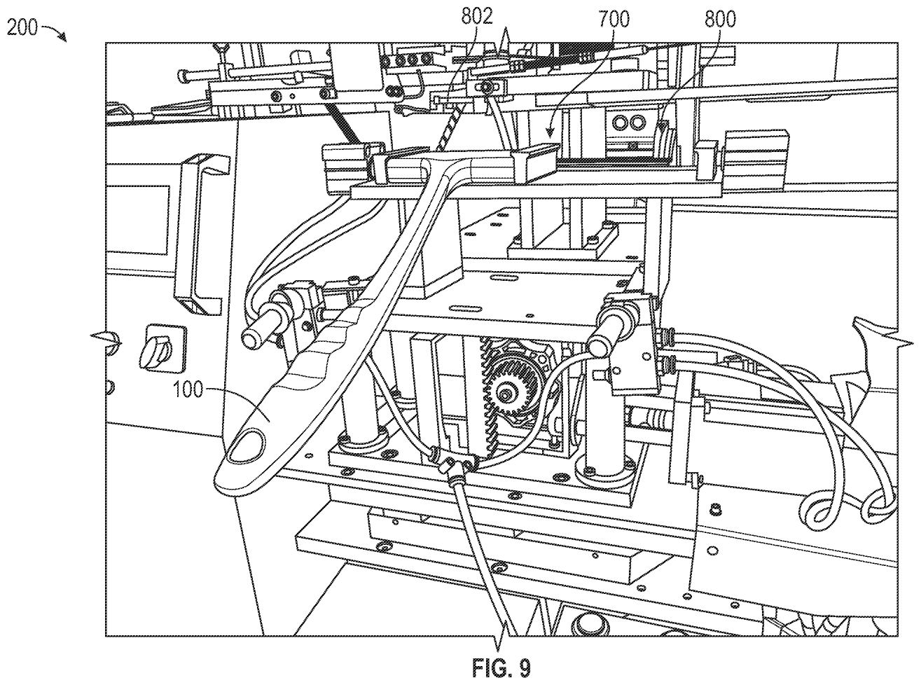

FIGS. 8 and 9 show fixture 700 of system 200. The fixture 700 is configured to clamp and position brush head 120 for the mechanical coupling of the plurality of bristles 152 to brush head 120. The fixture 700 generally includes a plate 702, two or more legs 714, 716 configured to mount the fixture to press machine 800, a fixed clamping finger 704, an adjustable clamping finger 706, and an actuator 710 configured to provide clamping force to the adjustable clamping finger 706. The actuator 710 may be software controlled. The fixture 700 is further configured to control a height of the plurality of bristles based on a vertical displacement of the fixture 700. The fixture 700 may be configured to control a height of the plurality of bristles 152, relative to a top surface 120a (FIG. 6) of the brush head 120. For example, by increasing the height of the fixture, the height of the plurality of bristles may be decreased by a similar amount, because a head 802 of the press machine 800 (FIG. 8) may insert the plurality of bristles 152 and the terminal 154 deeper into the recess of the brush head 120. In aspects, the fixture 700 is configured to have a suitable height and shape for different types of grill brush 100 designs utilizing different shapes and thickness of handles 110 and brush heads 120. For example, for a larger sized brush head the clamping finger 704 and the adjustable clamping finger 706 of about 25.5 mm tall (+/−about 0.3 mm) may be used to clamp the brush head 120. In another example, for a smaller sized brush and head, the clamping finger 704 and the adjustable clamping finger 706 of about 15.5 mm tall (+/−about 0.3 mm) may be used to clamp the brush head for the plating process.

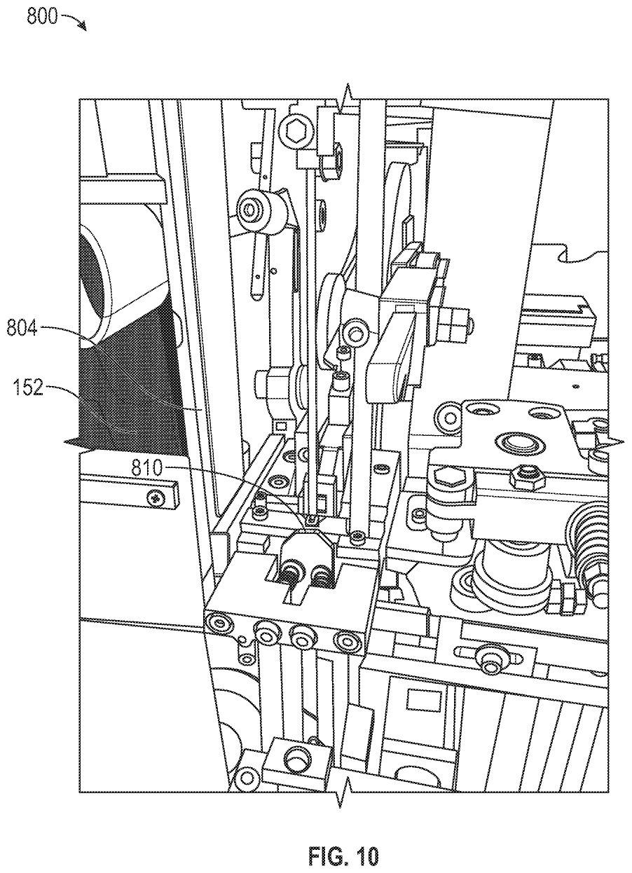

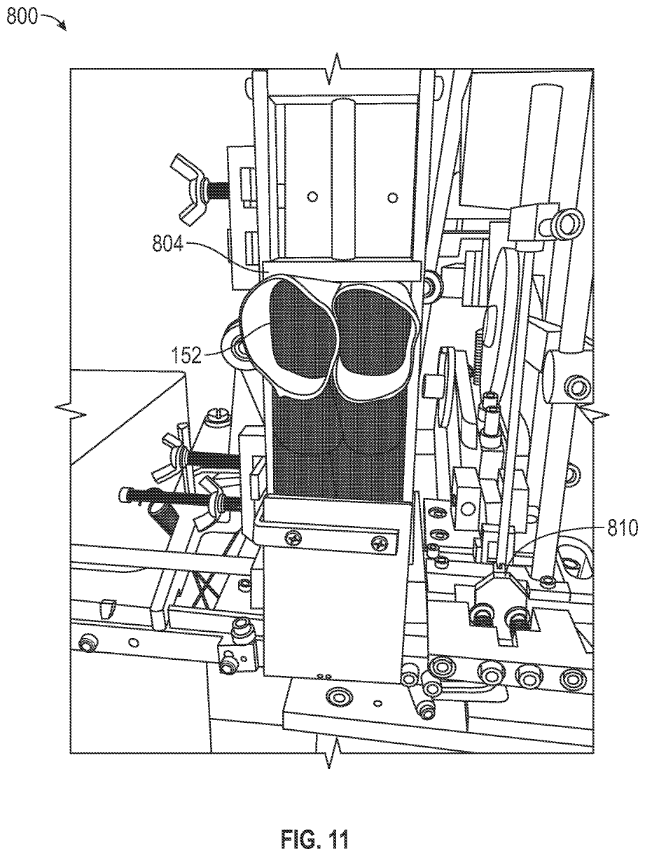

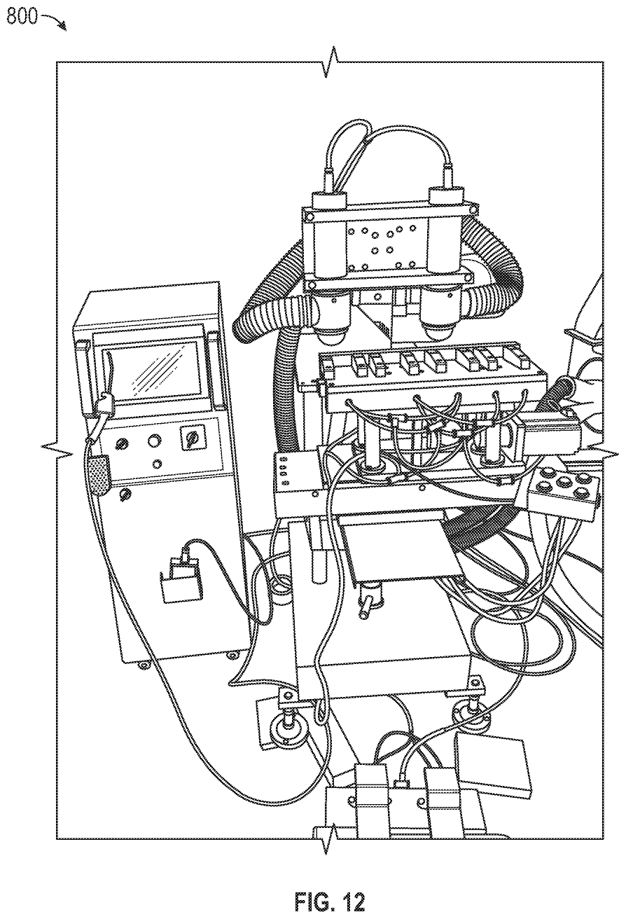

FIGS. 10-12 show press machine 800 of system 200 of FIG. 1. The press machine 800 is configured to mechanically couple the plurality of bristles 152 to the brush head 120 of the grill brush 100. The press machine 800 is configured to control the force used to mechanically couple the plurality of bristles 152 and to deform terminal 154. The press machine 800 is configured to control a location of bristle grouping 150 in brush head 120 based on controlling at least one of a vertical displacement or a horizontal displacement of brush head 120. The press machine 800 is further configured to control the applied force to deform terminal 154 in the recess of brush head 120. The press machine 800 is further configured to mechanically couple the plurality of bristles 152 to brush head 120 such that the plurality of bristles 152 is not detached or compromised when a force of greater than about 89 Newtons is applied. In aspects, press machine 800 is further configured to control a height of the plurality of bristles 152 by controlling a vertical displacement of head 802 of press machine 800 relative to the top surface 120a of brush head 120. The press machine 800 may further include a hopper 804 for holding bristles 152 during production (FIG. 11). The hopper is configured to feed the plurality of bristles 152 to recess 130 of brush head 120. The press machine 800 may include a forming head 810 configured for forming terminals 154 from wire.

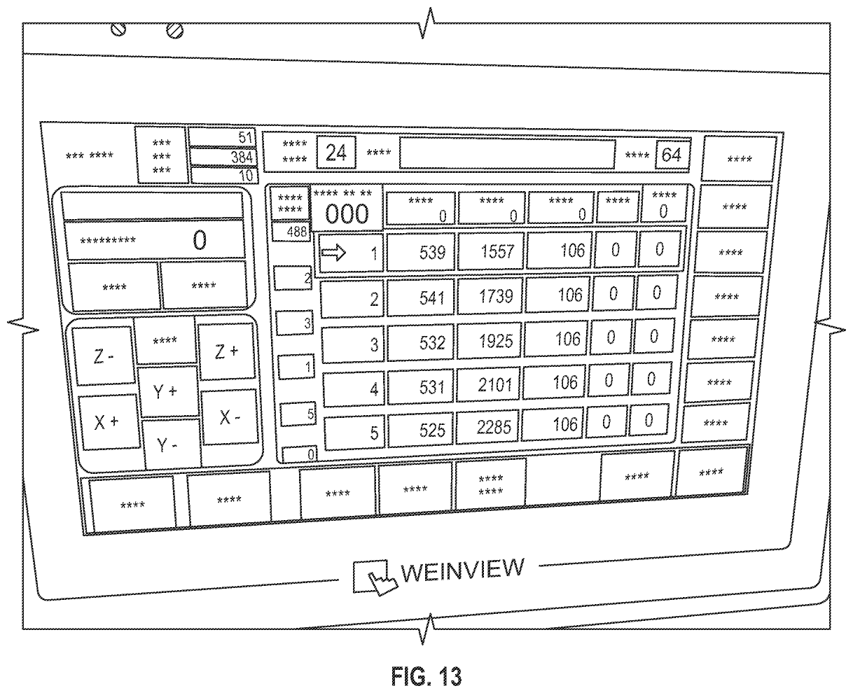

FIG. 13 shows an example control screen of plating machine 800 of FIG. 1. The control screen enables setting up and configuring press machine 800. For example, initially a user may adjust the Z Axis. A machine height of press machine 800 may be adjusted by an adjustable cylinder. The machine height controls the height of fixture 700 which is used to clamp brush head 120 properly for the disclosed method.

As can be appreciated, securement of any of the components of the disclosed systems can be effectuated using known securement techniques such as welding, crimping, gluing, fastening, etc.

The phrases “in an aspect,” “in aspects,” “in various aspects,” “in some aspects,” or “in other aspects” may each refer to one or more of the same or different aspects in accordance with the present disclosure. Similarly, the phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques).

Certain aspects of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

Persons skilled in the art will understand that the structures and methods specifically described herein and illustrated in the accompanying figures are non-limiting exemplary aspects, and that the description, disclosure, and figures should be construed merely as exemplary of particular aspects. It is to be understood, therefore, that this disclosure is not limited to the precise aspects described, and that various other changes and modifications may be effectuated by one skilled in the art without departing from the scope or spirit of the disclosure. Additionally, it is envisioned that the elements and features illustrated or described in connection with one exemplary aspect may be combined with the elements and features of another without departing from the scope of this disclosure, and that such modifications and variations are also intended to be included within the scope of this disclosure. Indeed, any combination of any of the disclosed elements and features is within the scope of this disclosure. Accordingly, the subject matter of this disclosure is not to be limited by what has been particularly shown and described.

What is claimed is:

1. A method for wire bristle tuft attachment, comprising:
clamping a brush head of a grill brush using a fixture;
arranging a plurality of bristles to form a bristle grouping using a terminal, wherein the plurality of bristles are adjacent and substantially parallel to one another;
inserting the plurality of bristles in a recess in the brush head; and
forming an irregular bend in the terminal by pressing the terminal into the recess by a press machine.

2. The method of claim 1, further comprising forming a terminal from a wire, wherein the wire has a metal cross-section, and wherein the terminal is made of metal.

3. The method of claim 1, further comprising controlling a height of the plurality of bristles based on a vertical displacement of the fixture.

4. The method of claim 1, further comprising controlling a height of the plurality of bristles by controlling a vertical displacement of a head of the press machine.

5. The method of claim 1, further comprising controlling a location of the bristle grouping in the brush head based on controlling at least one of a vertical displacement or a horizontal displacement of the brush head.

6. The method of claim 1, wherein the press machine is further configured to mechanically couple the plurality of bristles to the brush head such that a strength and durability of the plurality of bristles is not compromised when a force of greater than about 89 Newtons is applied.

7. The method of claim 1, wherein the brush head is made of polypropylene.

8. The method of claim 1, wherein a diameter of the recess is about 2.5 mm.

9. The method of claim 1, wherein a length of the terminal is between about 2.2 mm to about 2.8 mm.

10. The method of claim 1, wherein a diameter of the terminal is between about 0.7 mm to about 0.8 mm.

11. A system for wire bristle tuft attachment, the system comprising:
a press machine configured to mechanically couple a plurality of bristles to a brush head of a grill brush by:
inserting the plurality of bristles in a recess in the brush head; and
applying a force to a terminal to form an irregular bend in the terminal by pressing the terminal into the recess; and
a fixture disposed on the press machine, the fixture configured to clamp and position a brush head for the mechanical coupling of the plurality of bristles to the brush head.

12. The system of claim 11, wherein the press machine is further configured to form the terminal from a wire.

13. The system of claim 11, wherein the fixture is further configured to control a height of the plurality of bristles based on a vertical displacement of the fixture.

14. The system of claim 11, wherein the fixture is further configured to control a height of the plurality of bristles relative to a top surface of the brush head.

15. The system of claim 11, wherein the system is further configured to arrange a plurality of bristles to form a bristle grouping using a terminal, and
wherein the press machine is configured to control a location of the bristle grouping in the brush head based on controlling at least one of a vertical displacement or a horizontal displacement of the brush head.

16. The system of claim 11, wherein the press machine is further configured to control the applied force to deform the terminal in the recess of the brush head.

17. The system of claim 11, wherein a length of the terminal is between about 2.2 mm to about 2.8 mm.

18. The system of claim 11, wherein a diameter of the terminal is between about 0.7 to about 0.8 mm.

19. The system of claim 11, wherein the press machine is further configured to mechanically couple the plurality of bristles to the brush head such that a strength and durability of the plurality of bristles is not compromised when a force of greater than about 89 Newtons is applied.

20. The system of claim 11, wherein the press machine is further configured to control a height of the plurality of bristles by controlling a vertical displacement of a head of the press machine.
